(19) United States
(12) Patent Application Publication
(10) Pub. No.: US 2026/0038358 A1
(43) Pub. Date: Feb. 5, 2026

(54) REAL-TIME EMERGENCY ASSISTANCE AND COMMUNICATION TECHNOLOGY (REACT) SYSTEM WITH INTEGRATED DRONE AND AI SUPPORT

(71) Applicant: Nicholas CHRIST, Mount Pleasant, SC (US)

(72) Inventor: Nicholas CHRIST, Mount Pleasant, SC (US)

(21) Appl. No.: 19/288,418

(22) Filed: Aug. 1, 2025

Related U.S. Application Data
(60) Provisional application No. 63/678,141, filed on Aug. 1, 2024.

(51) Int. Cl. G08B 25/01; G05D 1/667; G05D 101/10; G05D 105/55; G05D 109/20; G05D 111/10; G06F 40/58; G08B 21/02

(52) U.S. Cl. CPC G08B 25/016; G05D 1/667; G06F 40/58; G08B 21/02; G05D 2101/10; G05D 2105/55; G05D 2109/20; G05D 2111/14

(57) ABSTRACT

According to one or more exemplary embodiments an integrated emergency response system designed to provide live multimedia reporting, drone-assisted surveillance, and AI-enhanced decision support in crisis situations, all while remaining distinct from prior systems may be provided. The system may include a user application, a responder application, and a command center that includes dispatch coordinate and AI integration.

### BACKGROUND

Emergency dispatch systems today face critical challenges that can lead to delays and inefficiencies in crisis response. Traditional 911 systems often rely solely on voice communication and provide limited real-time visual insight into an incident. As a result, first responders may arrive on scene with incomplete information, increasing risks to victims and responders. Furthermore, legacy systems lack integration between callers, field personnel, and external resources like unmanned drones or public input channels. Issues such as inaccurate caller location data, misrouted calls near jurisdictional boundaries, language barriers, and system overload during major incidents all contribute to slower response and diminished situational awareness.

Recent advances in public safety technology have begun to address parts of this problem, but significant gaps remain. For example, situational awareness platforms like Motorola Solutions' CommandCentral Aware aggregate real-time data onto a common interface. CommandCentral Aware can ingest 911 call information, track first-responder GPS locations, and integrate live video feeds from nearby cameras, presenting a unified map and dashboard for dispatchers. It even ties into sensor inputs and wearables to raise alerts when an officer's weapon is drawn or if a “man down” event (e.g. gunshot, vest piercing, or vehicle crash) is detected. Separately, body-worn camera systems such as Axon's Body 3 provide frontline officers with connected video recording devices that stream live footage and GPS location to command centers. Axon's platform (with its Axon Aware™ service) offers features like real-time video livestreaming from the field, live mapping of officer locations, and automated event alerts aimed at improving officer safety. These developments illustrate a trend toward greater connectivity and real-time information flow in emergency response.

However, existing solutions do not fully solve the aforementioned challenges and in some respects remain limited. CommandCentral and similar systems largely consume data from official sources (e.g. professional responders' devices, fixed IoT sensors) but lack direct integration of live multimedia. Likewise, any use of aerial video requires manual action and separate systems. While Axon's Body 3 and related products focus on officer-worn cameras, they do not provide a mechanism for unmanned aerial reconnaissance or civilian smartphone reporting to feed into the same incident picture. Additionally, language barriers remain an issue; to the extent translation services exist, they are often manual (requiring human interpreters or separate tools). Cross-agency coordination is another shortcoming: existing tools may be agency-specific, making it cumbersome to share live data between police, fire, medical, and federal responders in a unified way.

### SUMMARY

According to one or more exemplary embodiments an integrated emergency response system designed to provide live multimedia reporting, drone-assisted surveillance, and AI-enhanced decision support in crisis situations, all while remaining distinct from prior systems may be provided. Referred to as Real-Time Emergency Assistance and Communication Technology (REACT), which may be understood to operate in at least some embodiments as a Real-Time Operating System (RTOS), according to at least one exemplary embodiment the system may comprise three main interoperable components:

A first component may be (1) a User Application (Caller-Side): A mobile application (or mobile-accessible interface) for use by the general public to initiate emergency reports with rich data. Unlike a standard phone call, this user app may enable real-time transmission of video, audio, and GPS location to 911 dispatchers as an incident unfolds. The caller may share live camera feed from their smartphone, upload photos or prerecorded clips, and/or send text descriptions or metadata (e.g. number of people involved, type of emergency) through an intuitive interface. The app may also collect vital personal information (such as medical conditions, allergies, or emergency contacts) in advance, which may be automatically relayed to first responders during an incident. If speaking is unsafe (e.g. during a home invasion), the user may activate a discreet reporting mode that streams audio from the device's microphone or allows silent text communication without visibly dialing or generating any noise e.g. through notifications. In scenarios where a caller does not have the app pre-installed, the system may send a secure 911 callback link via SMS to their phone; which upon clicking may immediately activate a browser-based live video feed to the dispatch center, achieving a similar result of live civilian input without a dedicated app. This may be understood to empower civilians to become live reporters of emergencies, providing responders with eyes and ears on scene prior to arrival—a capability not present in conventional 911 systems.

A second component may be (2) a First Responder Application (Responder-Side): The first responder application may include a tablet or mobile application for police, fire, EMS, and/or other responders that receives the integrated incident data and provides on-the-move situational awareness. Through this interface, first responders may view detailed maps with incident locations and the GPS positions of other responding units. They may further see live video feeds coming from a caller's smartphone and/or any deployed drones, as well as feeds from other sources such as, for example, nearby traffic or surveillance cameras if available. The responder app may consolidate incoming alerts and annotations—for example, the dispatcher or an AI assistant might mark hazards on the map (like “building exit on east side” or “suspect seen holding a weapon” based on video analysis). The app may further allow responders to import incident data directly into their reports or investigation notes, streamlining documentation. Additional tools may include, but are not limited to, environmental condition readouts (weather at scene, time of day) and room-scanning AR technology for indoor incidents (using the device camera to map room dimensions or identify heat signatures, aiding search and rescue and evidence collection). Responders with proper credentials may quickly access linked databases (for example criminal records, building floor plans, and/or medical info from the caller's profile) through the app, all while en route. By aggregating all critical incident information in a single handheld view, the first responder app may ensure that field personnel have a comprehensive, up-to-date picture, which may be understood to improve responder safety and effectiveness.

A third component may be (3) Dispatch Coordination & AI Integration (Command Center Side): A coordination module may be provided at a dispatch or command center and may form the intelligent backbone of the system, linking the user and responder applications and augmenting them with additional data sources and/or AI-driven analysis. This module may automatically deploy unmanned aerial vehicles (drones) to the incident location in appropriate situations. For example, if a high-priority emergency (such as a traffic accident, fire, or security threat) is reported, the system may immediately launch a camera-equipped drone from a nearby station. The drone may navigate to the scene using, for example, the caller's GPS coordinates and may begin streaming live aerial video back to the dispatch center and responder apps. This may provide an overhead view of the incident before any personnel arrive. Drones may be equipped with infrared/thermal cameras to detect heat signatures—critical for finding survivors at night or in burning buildings—and/or with low-light night vision for darkness or smoke. The dispatch module's AI may analyze these video feeds in real time, automatically detecting hazards or important events. For instance, it may flag the presence of weapons, identify the number of people in a crowd, detect an overturned vehicle or fire spread, and/or recognize if a person is lying motionless on the ground. These insights may then be relayed as alerts or overlays to dispatchers and/or first responders.

Additionally, the dispatch coordination system may integrate multi-source audio/video and/or sensor data. It may perform real-time language translation for communications with callers who speak a non-English language. When a 911 call or live chat is received in, for example, Spanish or Mandarin, the system's AI-driven translation engine may instantly transcribe and/or translate the caller's speech or text into English (or any other target language used by the dispatcher), and may likewise translate the dispatcher's responses back into the caller's language. This may be understood to ensure that language barriers do not delay critical information exchange during emergencies. The module may also automatically fill key data fields in a Computer-Aided Dispatch (CAD) system: it may parse the user's profile and incident description to populate incident type, location, caller info, etc., which may reduce manual data entry for dispatchers.

The REACT dispatch module may further act as a unified communication hub across multiple agencies and jurisdictions. It may share live incident information simultaneously with police, fire departments, emergency medical services, and/or other relevant agencies on a need-to-know basis. Through a secure cloud-based platform, a major incident's video feeds, maps, and updates can be pushed to all involved agencies' operations centers in real time. This cross-agency interoperability may ensure that, for example, police and firefighters responding to the same incident have access to the same real-time drone feed and civilian video, and that a neighboring jurisdiction can seamlessly take over or assist if an incident crosses geographic boundaries. All communications and data may be logged with timestamps and source identifiers to maintain a coherent timeline.

It may be understood that the REACT system may leverage community-sourced data in ways conventional systems do not: not only can civilians send information to 911, but the system can also crowdsource and disseminate broader incident-related updates. For instance, other users in the vicinity may receive push alerts about the emergency (or hazards like road closures) and may respond with additional on-scene information or confirm details, creating a more complete operational picture. The integration of drone technology directly into the 911 workflow is another unique aspect—upon an emergency trigger, drones act as “first observers” in the sky, under automatic guidance from the dispatch AI, rather than requiring a separate manual deployment process. The inclusion of AI translators and analytical assistants means the system can handle complexities (like multi-lingual callers or large data streams from video) that historically required human intervention or were simply not addressed.

All captured data may flow into a centralized incident log, enabling automated incident report generation. As the incident progresses, REACT's software may aggregate the caller's inputs (audio transcript, videos, etc.), the drone's footage and sensor readings, responder telemetry (GPS tracks, heart rate if biometric sensors are used, etc.), and any dispatcher annotations. The system may compile this into a structured incident report or timeline, which may be used for, for example, after-action review, evidence, or official reporting. This report may include a chronological narrative generated with the help of AI—for example: “Dispatch received a call at 14:03 from a caller reporting a building fire, location X. Live video was transmitted by the caller. Drone #7 launched at 14:04 and arrived on scene at 14:06, providing aerial infrared footage that detected two heat signatures on the second floor . . . ” and so on. Such a feature may be understood to ease the burden on officers to manually write reports later, and ensures accuracy and preservation of all details.

their may be therefore understood that according to at least one exemplary embodiment REACT may provide a comprehensive, real-time incident management system. on the system may further feature newly enabled functionalities: direct civilian multimedia participation, autonomous drone integration, AI-driven multilingual support and data analysis, and seamless multi-agency coordination. By doing so, the system may significantly improve emergency outcomes—reducing response times through better information, enhancing responder safety via advanced warning of conditions, and increasing the chances of saving lives and property with a faster, smarter response. The system may further be scalable nationwide and may be implemented as, for example, an upgrade to current 911 and public safety infrastructures, providing a next-generation solution to emergency communication challenges.

### BRIEF DESCRIPTION OF THE FIGURES

Advantages of embodiments of the present invention will be apparent from the following detailed description of the exemplary embodiments. The following detailed description should be considered in conjunction with the accompanying FIGURES in which:

FIG. 1 shows an exemplary REACT system architecture.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Large Language Models (LLMs), transformers, decision trees, random forests, expert systems, mixture of experts models, ensemble models, diffusion models, and autoencoder models, to name a few. However, many other forms of AI and ML architectures that enable the processor to perform the same functionality have been considered.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

As used herein it may be understood that drone and Unmanned Aerial Vehicle (UAV) may be used interchangeably.

In one or more exemplary embodiments a Real-Time emergency assistance and communication system and method may be provided.

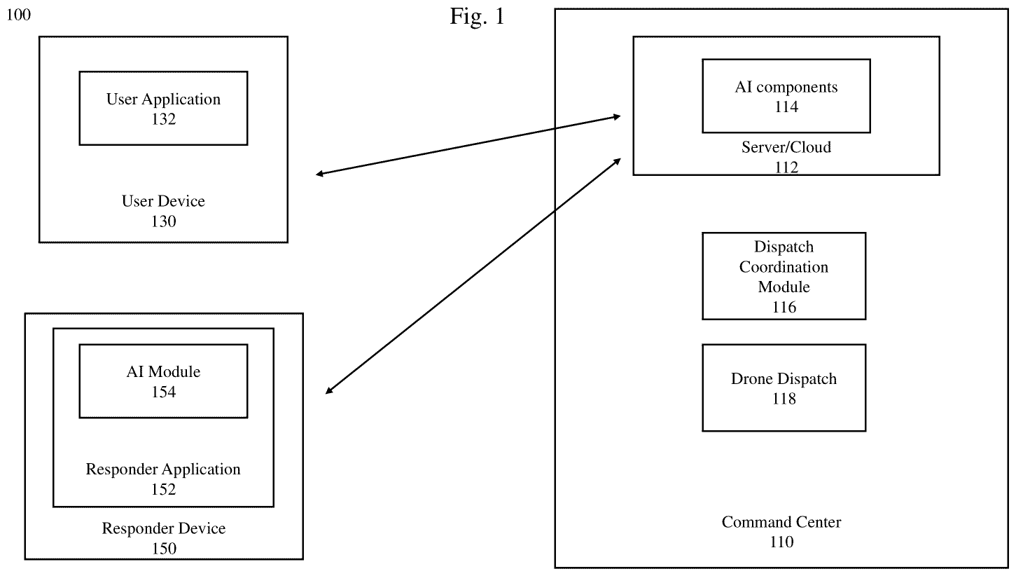

Referring to FIG. 1 generally, an exemplary system architecture may be briefly explained: according to one or more embodiments, the REACT system 100 may be implemented as a networked software platform comprising at least one server or cloud module 112 at a command center 110 and various client applications for end-users (callers) and first responders. The server 112 coordinates data flow and may host the AI analytic components 114. Communication between components can occur over secure internet connections or dedicated public safety networks. End-to-end encryption and authentication may be employed for all video, audio, and data transmissions to maintain security and privacy.

User Application (Caller Interface): In an embodiment, the user-side application 132 may be a smartphone app downloadable by a public user on a user device 130. When the user initiates an emergency report (for example, by pressing a panic button or calling 911 through the app), the following sequence may occur: The app may immediately send the user's precise GPS coordinates (using the phone's GPS) and the user's identity/profile to the REACT server 112. The user may then be presented with options to stream live video or audio. For example, a UI button may say “Show Video to 911”—upon tapping, the app may activate the phone camera and begin streaming video (with audio) directly to the dispatcher's console. If the user cannot speak (for example in a situation where an intruder is present), simply activating this feature may quietly share crucial visuals without alerting others. The app's interface may further support text chat with 911, so the caller may type or otherwise communicate details if talking aloud is not possible or if background noise is too loud for a call. This text may be relayed in real time to dispatch. The app may leverage the phone's sensors as well—for instance, it may automatically detect if the user device 130 was subject to a high impact (using accelerometer data) which might indicate a car crash, and then may automatically trigger an emergency alert with location even if the user is incapacitated. This sensor-trigger aspect may ensure help can be sent even without a manual call in some cases, and may be configurable to avoid false alarms.

Importantly, if a person without the app dials 911 from a cellular phone, the REACT system 100 may still engage them in rich data transfer. The dispatcher's system may send a text message with a URL to that caller's phone number. On the caller's end, clicking this URL may open a secure web page (hosted by REACT) that activates their camera and microphone with permission, feeding video/audio to dispatch just like the app would. This web-based emergency link feature may be understood to greatly expand the reach of REACT's live reporting capability, ensuring that even first-time 911 callers or tourists (who may not have the app) can provide live footage when needed. The system may ensure the caller cannot inadvertently send video without consent by requiring they click the link and allow camera access, respecting privacy while enabling crucial data sharing when help is needed.

The user application 132 may also allow pre-registration of medical information and emergency contacts or designated next of kin, which are stored securely. In an emergency, these may be automatically displayed to dispatchers and first responders. For example, if a user has a severe allergy or a heart condition, that info may appear on the responder's tablet, enabling medics to prepare appropriate treatment en route. Similarly, the app may notify the user's emergency contacts with a text alert if the user calls 911, optionally sharing the location and nature of the emergency—a feature that may keep loved ones informed. In some embodiments the user application 132 may automatically enable direct interaction with the emergency contact or designated next of kin. In some scenarios the automatic relay may be triggered by one or more conditions, for example detection that the user is unconscious.

In some embodiments the user application 132 may have further features including, for example, enabling users to report faulty traffic lights, hazardous road conditions, etc. In some embodiments user reports may be automatically sent to, for example, local authorities and/or DOT contacts or systems.

First Responder Application (Field Interface): The responder-side application 152 may run on a plurality of responder devices 150, for example but not limited to, computers, phones, mobile devices, tablets mounted in police vehicles, fire trucks, ambulances, or on handheld rugged tablets carried by officers. In one embodiment, when an incident is reported via REACT, responders may get a push notification on their device (if they are assigned or in the vicinity) with basic details: for example, type of incident, location, and a summary of any initial notes. Upon opening the incident in the app, a map view centered on the incident location may be displayed on the device 150. This map may show icons for any deployed drones, the caller's device (if streaming, it may further show an icon with live video thumbnail), and/or icons for other responders who are on route or on scene (each identified by unit or badge ID). Responders may switch to a video view to watch live streams: the caller's smartphone feed (if active) and the drone's feed may both be available. The interface might allow toggling between camera views or seeing them side-by-side. Additionally, if city traffic cameras or security cameras (CCTV) near the scene are integrated, dispatch may push those feeds to the app as well. This may give responders multiple angles of situational awareness.

In at least some embodiments the responder app 152 may further serve as a real-time data logger and assistant. The app 152 may record voice notes or take photos that automatically tag to the incident record. For instance, a firefighter can use the responder device 150 to take a photo of a building's gas line damage; that photo is time-stamped and uploaded to the incident timeline for later analysis and insurance use. In at least some embodiments the device's camera and possibly additional sensors (like LiDAR if available on some tablets or phones) may be used to create a quick 3D scan of a room or area via room scanning. This could be used by, for example, a fire marshal or crime scene unit to document the scene geometry. The scan data may be attached to the incident record so investigators later can examine a 3D model of, say, the accident site.

The responder app 152 may also include an AI virtual assistant 154 that can be queried via voice or text. For example, a police officer could ask, “Have we gotten any reports from this address before?” and the system might query the database to answer if that location had prior 911 calls (helpful for context, e.g. history of domestic disturbances). Or a responder might ask in the app, “Translate what the caller is saying,” and if the caller is still connected speaking a foreign language, the app will display the translated text in near real-time. This may be understood to be a front-end utilization of the backend translation feature, ensuring responders on scene understand communications if, for example, they encounter a non-English-speaking victim.

Dispatch Coordination Module and Drone Integration: In at least one exemplary embodiment the dispatch center's software (which could be a cloud service accessible to authorized dispatchers on their workstations) is the central brain orchestrating all pieces, and may include a dispatch coordination module 116. When an emergency report comes in, the system may classify it (using, for example, either the user's input or AI analysis of the call/video) into categories such as medical, fire, crime in progress, etc., and may further assign a priority level. Based on this and location, the system may make a recommendation and/or may automatically initiate drone deployment.

For drone integration, the system may maintain a network of readily deployable drones stationed strategically (e.g. on rooftops or patrol vehicles) to cover various areas which may be coordinated by a drone dispatch module 118. Each drone may be equipped with cameras and/or specialized sensors for example, thermal imaging, night-vision, LiDAR for mapping terrain, speakers for making announcements, and/or spotlights to illuminate areas at night, etc. The specialized sensors utilized may be dependent on, for example, the model and use case of the drone. The drones may operate either autonomously or semi-autonomously. In one embodiment, as soon as a high-priority incident is identified, the nearest available drone may be automatically dispatched by the system: the drone's onboard GPS may be fed the incident coordinates, and the drone may launch and navigate automatically at high speed (subject to flight safety rules).

The dispatch module 118 may continuously monitors the drone's telemetry. In some embodiments the drone may have object detection AI on board or via the backend, and may, for example, identify a person lying on a road or detect motion in a perimeter if responding to a security incident. The system may highlight these on the dispatcher's screen (e.g. drawing a red bounding box around a person it spots on the drone video). The dispatcher and responders may also control the drone's camera angle or ask it to zoom via the interface if needed. All the while, the drone feed may be recorded and stored in the incident's digital vault (for evidentiary purposes).

Notably, drones in the system may act as more than passive eyes and may be further outfitted to actively assist. For example, in maritime emergencies, if someone falls overboard a ship or is stranded at sea, a drone may drop a self-inflating life raft or flotation device to the victim. In a wilderness search-and-rescue, a drone may carry a first aid kit, water bottle, or emergency beacon to a lost hiker. In some embodiments the drone may be further equipped with speakers and LED lights to project sound and/or emit light patterns signaling different scenarios. The REACT system may support such deployments by allowing dispatchers to select a payload drone and a drop target (guided by the drone's camera). This autonomous aerial supply delivery may extend the window of survivability for victims before human rescuers arrive. All such drone actions (e.g. “supply pod delivered at coordinates X at time Y”) may be logged by the system.

In some embodiments one or more specialized drones may be contemplated. For example, some drones may be specialized indoor drones equipped with, for example, high-definition 360-degree cameras and advanced sensors to document and/or analyze crime scenes. In some embodiments the drone may be equipped with a specialized camera that may capture forensic evidence, for example blood splatter patterns, shell casings, and other trace materials, and may cross reference the forensic data one or more databases for example historical crime data or serial offender patterns. Some drones may have further specialized aspects, for example fire resistant coatings, thermal imaging cameras or sensors, etc.

In some embodiments the drone may be programmed to detect suspicious activity, for example gunfire or cries for help, and may automatically and autonomously deploy to investigate the suspicious activity.

In some embodiments the system may further integrate with local databases such as from a local planning commission in order to import structural information about a building. The structural information may include, for example, construction materials, year built, floor plans, gas line locations, presence of elevators or staircases, etc. Other information may be obtained from, for example, recent layouts and photos from any public data source, for example MLS listings, public websites, etc, in order to provide first responders, swat teams, or drones with a visual preview of a relevant buildings interior.

In some embodiments one or more buildings may be pre-scanned, e.g. cameras and sensors may be used to generate pre-scan data of a government building, school, park, etc. The pre-scan data may be utilized in conjunction with live feeds during an incident in order to provide information to responders and/or after an incident to provide information for evidence or incident reports.

The dispatch coordination module's AI may further handle data fusion and distribution. As data comes in from various sources (e.g. user app, drones, responder statuses), the system may correlate and aggregate metadata. For example, the system may tag video streams with location and time and link the caller's video with the drone's overhead video if they are of the same scene (so an analyst later can play them in sync or see picture-in-picture). The AI may further generate alerts like “multiple callers reporting the same incident” and merge those incidents in the queue for efficiency. In terms of distribution, if an incident potentially involves federal agencies (for example a possible terrorist incident or a highway that is state jurisdiction), the system may bridge communications so that those agencies see the incident data as well while bypassing manual phone calls and emails. In some embodiments the system may further determine a callers exact floor or altitude based on data obtained from the user app.

In some embodiments the dispatch module AI may automatically detect and blur graphic content in photos or videos sent to the dispatch. The AI may further verbally describe contents of an image or video to the dispatcher, in some scenarios the description may be triggered by detection of graphic or potentially graphic content.

Multi-Agency and Community Integration: The REACT system may be flexible and expandable for various emergency domains. For law enforcement, it may provide tactical advantages (real-time intel, building layouts, suspect tracking via drone). For fire and rescue, it may offer early size-up of fires through aerial imagery and/or the ability to locate hotspots or victims via thermal scans. For medical responders, it may transmit live video of patient condition and even enable a dispatcher-guided CPR by showing a caller how to perform it while the ambulance is en route (the dispatcher can see and coach the caller through the user's smartphone camera).

Specialized modules may be incorporated in various embodiments. For instance, a Coast Guard mode of the system may integrate national distress signal data like signals from EPIRB beacons or calls via marine radio into REACT. If a distress call comes from a boat, REACT may deploy a drone over water (for example from a Coast Guard cutter or shoreline station) to start searching for the vessel or person overboard, using object recognition to spot human heads or boat hulls on the waves. The system may then relay the drone's coordinates of the found person to the rescue boats and/or to nearby civilian vessels (for example through a marine safety app), effectively creating a collaborative rescue network. For homeland security or defense, the platform may integrate with border sensors or military operations—e.g., motion-triggered drones for border surveillance, with live feeds analyzed for unauthorized crossings, which can then hand off to Border Patrol agents. The multi-agency communication platform may ensure that a situation that escalates, like a disaster requiring National Guard plus local police and FEMA, can be managed on one system. Each agency may be enabled to see the parts of the incident relevant to them and may contribute updates to the shared timeline.

Data Security and Compliance: Given the sensitive nature of emergency data, the system may employ robust security measures. All user-provided data and video streams may be encrypted in transit and at rest. Access controls may ensure that only authorized personnel, for example dispatchers, assigned responders, etc., can view live feeds or personal data. The system may be configured to comply with CJIS (Criminal Justice Information Services) standards in the U.S., HIPAA for any medical info, and/or other relevant regulations. In practice, this means audit logs of who accessed data, time-based auto-deletion of certain user videos unless needed for evidence, and obtaining user consent where appropriate (e.g., the app's terms cover that emergency data will be shared with agencies).

System Redundancy: The REACT platform may in some embodiments include satellite communication integration as a backup. During disasters that knock out local infrastructure such as hurricanes or wildfires, the system may switch to satellite links (e.g., Starlink or similar satellite internet, or satellite push-to-talk radios) to keep the data flowing to and from incident scenes. This may ensure continuity of operations even when cell towers or internet lines are down, which may be understood to increase system resilience.

Through these detailed embodiments, may be understood that the REACT system provides a combination of features that dramatically improve emergency response capabilities. It should be understood that various modifications can be made without departing from the scope of the invention—for example, incorporating future sensors (like gunshot detection microphones on drones, or integration with smart city IoT signals for fire alarms) to enhance the system. The true scope of the invention, therefore, is defined not by the specific examples given, but by the claims that follow, which cover all such variations and improvements that leverage the core idea of AI-enhanced, drone-integrated, multi-source emergency response coordination.

The foregoing description and accompanying FIGURES illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for enhanced emergency incident reporting and response coordination, comprising:
a user-side emergency application executable on a mobile device of a reporting party, configured to transmit real-time incident data of an incident including at least live video, audio, and GPS location to an emergency dispatch upon initiation of an emergency report, and further configured to provide pre-stored personal medical and contact information of a user associated with the user-side emergency application to the emergency dispatch;
a first-responder application executable on a computing device carried by a first responder, configured to receive the real-time incident data, display live video feeds and maps of the incident, and present synchronized incident information and alerts to the responder; and
a dispatch coordination module communicatively coupled with the mobile device and the computing device carried by the first responder, the dispatch coordination module comprising an integrated analytics and control system configured to automatically deploy an unmanned aerial vehicle (UAV) to the vicinity of the incident based on the GPS location data, establish a live video/audio feed from the UAV to the first-responder application and a dispatch center, and utilize an artificial intelligence engine to analyze incoming data for event-specific insights.

2. The system of claim 1, wherein the dispatch coordination module assigns a severity rating to the incident;
automatically launches and navigates the UAV to the incident scene upon detection of a high-severity incident; and
streams aerial video from an onboard camera of the UAV to the first-responder application.

3. The system of claim 2, wherein the UAV is equipped with at least one of: a thermal imaging sensor configured to detect heat signatures of persons or hazards in low visibility conditions, and a night-vision camera.

4. The system of claim 3, wherein the dispatch coordination module further comprises an artificial intelligence engine that analyzes the UAV's video feed to automatically identify targets or threats.

5. The system of claim 3, wherein the unmanned aerial vehicle further comprises a payload delivery mechanism and is configured to autonomously deliver emergency supplies to one or more persons at the incident scene;
wherein the dispatch coordination module coordinates the drop location and timing; and
wherein the delivery is automatically logged in an incident report and communicated to the first-responder application.

6. The system of claim 5, wherein the supplies include at least one of medical kits or flotation devices.

7. The system of claim 1, wherein the dispatch coordination module further comprises a real-time language translation subsystem configured to receive audio or text communication from the user-side emergency application, detect a non-english language is being used, and automatically produce a translated transcript or audio in a language used by the first-responder application.

8. The system of claim 1, wherein the dispatch coordination module is further configured to continuously aggregate and synchronize the real-time incident data from at least the user-side emergency application, a UAV feed, one or more responder inputs, and IoT sensor data.

9. The system of claim 8, wherein the dispatch coordination module is further configured to generate an incident report that chronicles the incident, the report comprising at least time-stamped entries of key events, uploaded multimedia, responder location tracks, and one or more system-generated analytical observations.

10. The system of claim 1, wherein the dispatch coordination module is further configured to enable communication between a plurality of responding agencies such that the plurality of responding agencies share a common real-time operational picture of the incident.

11. The system of claim 10, wherein the dispatch coordination module coordinated communication between a plurality of agencies such that each of the plurality of agencies has concurrent access to the real-time incident data; and
wherein the dispatch coordination module manages user permissions and data routing so that each of the plurality of agencies sees the real-time incident data in substantially real time.

12. The system of claim 11, wherein the plurality of agencies includes at least a police agency, a fire agency, and a medical agency.

13. An emergency response method, comprising:
receiving an emergency alert along with live video and location data from a mobile user device via a user application;
automatically dispatching a drone to the provided location upon classifying the emergency as requiring aerial support;
streaming video from the dispatched drone and the mobile user device to first responders and dispatch personnel in real time;
analyzing the videos using machine learning algorithms to detect predetermined critical events or objects;
generating one or more alerts upon detection of at least one critical event or object;
delivering situational updates concurrently to multiple responding agencies through a unified interface; and
logging all received data into a time-sequenced incident report.

14. The emergency response method of claim 13, further comprising:
determining a language of the mobile user device is different from a language of the first responders;
automatically translating at least one communication from the mobile user device to the first responder in real time.

15. The emergency response method of claim 13, wherein the one or more alerts includes at least one of an alert for a weapon, an alert for an injured person, or an alert for an evolving hazard.

16. A system for enhanced emergency incident reporting and response coordination, comprising:
a first-responder application executable on a computing device carried by a first responder, configured to receive real-time incident data, display live video feeds and maps of an incident, and present synchronized incident information and alerts to the responder;
a dispatch coordination module communicatively coupled with a mobile device and the computing device carried by the first responder, the dispatch coordination module comprising an integrated analytics and control system configured to automatically deploy an unmanned aerial vehicle (UAV) to the vicinity of the incident based on the GPS location data, establish a live video/audio feed from the UAV to the first-responder application and a dispatch center, and utilize an artificial intelligence engine to analyze incoming data for event-specific insights,
wherein the dispatch coordination module is further configured to send a secure callback line to a user's mobile device when an emergency call is received, the link upon activation enabling transmitting real-time incident data of the incident including at least live video, audio, and GPS location.
